(19) United States
(12) Patent Application Publication
(10) Pub. No.: US 2003/0064138 A1
(43) Pub. Date: Apr. 3, 2003

(54) Frozen dough having decreased proof time

(75) Inventors: Dennis A. Lonergan, Media, MN (US); Tammy L. McIntyre, Minneapolis, MN (US)

Correspondence Address: Dale A. Bjorkman, Kagan Binder, PLLC, Maple Island Building, 221 Main Street North, Suite 200, Stillwater, MN, 55082, US

(73) Assignee: The Pillsbury Company

(21) Appl. No.: 09/955,832

(22) Filed: Sep. 19, 2001

(51) Int. Cl. A23B 4/00

(52) U.S. Cl. 426/128

(57) ABSTRACT

A frozen dough product is provided, comprising an unproofed frozen dough product comprising a leavening agent. The dough product is contained in an atmosphere enriched in a carbon dioxide concentration in an amount sufficient to enhance proofing of the frozen dough product as compared to a like frozen dough product not contained in an atmosphere enriched in carbon dioxide. Methods of manufacture and methods of use are also described.

### FIELD OF THE INVENTION

The present invention relates to frozen dough. More specifically, the present invention relates to frozen dough having a decreased proof time.

### BACKGROUND OF THE INVENTION

In making bakery items, for example, bread, rolls, pastry, etc., a multi-step process is used. The process is labor and machinery-intensive and is also time consuming. Dough can be produced in one of several conventional manners, for example, by the sponge method or the straight-dough method. In the sponge method, yeast, yeast food, water, some flour, and sucrose are mixed and then held to allow the yeast time to begin fermentation and to produce carbon dioxide and ethanol. Thereafter, remaining flour, some additional water, and minor dry ingredients are mixed with the preceding blend to form the dough, after which the dough is processed, for example, by sheeting or other known processing techniques. After forming the dough into its final form, the dough is proofed and then subsequently cooked, for example, by baking or frying.

The sponge method of dough preparation is generally considered to be better because this method makes a dough of better flavor and is considered a “standard” dough-making procedure. However, the sponge method takes longer than other dough-making procedures. The entire process, including proofing, can take up to eight hours.

Another dough manufacturing process is a straight-dough process. The straight-dough process includes a step of mixing all of the flour, minor dry ingredients, water, yeast food and yeast. The dough is mixed and optionally fermented for zero to sixty minutes, readied for forming, cut and formed into an appropriate shape and then proofed. One advantage of the straight-dough method is that it is quicker than the sponge method and requires less equipment. It generally does not make a bread of the same flavor and generally does not provide the same quality as bread made by the sponge method. Even through the straight-dough method is quicker than the sponge method, this method can take up to four hours to complete sufficient proofing.

A third process of manufacturing dough is a continuous process. Typically, a pre-ferment, comprising a fermented slurry of yeast, water, yeast food and some sugar and flour is combined with remaining dough ingredients, continuously mixed, cut into the appropriate size and shape and proofed. This particular method of dough manufacture is infrequently used because it is considered by the industry to produce a low quality, low-flavor baked product and is equipment intensive.

The above processes have been used for a number of years, both in industry and in the home in simplified forms. As described, the processes are equipment and time intensive. There has been a recent interest in providing fresh-baked products to consumers, as is evidenced by an increased number of in-store bakeries. These bakeries provide fresher products than those delivered from a plant to the store. The time and equipment necessary to produce such products on site is somewhat prohibitive, however. It would, therefore, be desirable to eliminate the dough preparation steps at the store, leaving it to the bakery to merely bake or otherwise cook the product.

Frozen doughs made by the methods described have become increasingly popular for consumers over the past decade. This popularity is related to improvements in organoleptic properties of breads made with frozen dough. These improvements are due, in part, to retention of yeast viability and retention of gassing power during a frozen storage of a dough.

There remain, however, areas where improvement have not been forthcoming. One of these areas relates to a reduction in stability of a dough matrix after freezing and thawing the dough. This reduction in stability typically produces a baked bread product having a specific volume that is less than a bread made with non-frozen dough. This bread with reduced specific volume has a “doughy” flavor and mouthfeel. Baked bread quality, exhibited by features such as texture, consistency and specific volume, deteriorates because of the shipping and storage conditions, particularly freeze-thaw cycles of the frozen dough.

One attempt to solve problems with frozen bread doughs is described in U.S. Pat. No. 4,374,151. This patent relates to a use of melting point depressant in a frozen, preproofed, uncooked bread dough. The expressed function of the melting point depressant in the frozen dough is to permit the dough to quickly soften in the oven as the temperature rises, permitting better oven spring during cooking. One of the described melting point depressants was ethanol.

Another patent addressing frozen dough problems is European Patent Application 84308045.8, filed Nov. 20, 1984. This Application relates to a method for producing yeast-leavened frozen pastry products which can be removed from the freezer and baked without the necessity of having to undergo further proofing or leavening. To eliminate the need for a lengthy thawing and proofing step prior to baking, the Patent Application described a slow freezing step.

U.S. Pat. No. 5,804,233 discloses a method for making a bread dough that remains unfrozen at a temperature as low as 0 degrees Fahrenheit and that has a specific volume and flavor, when baked after storage at freezing temperatures, that is substantially the same as bread baked from a non frozen dough not subjected to storage. The dough contains ethanol, glycerol or other alcohols or polyols to partially swell and/or solubilize proteins within the dough defining gas cells. Carbon dioxide is provided in the container in a quantity effective to minimize escape of carbon dioxide from the dough. The dough product as described in this patent therefore is first proofed, and is then frozen and stored.

U.S. Pat. No. 5,366,744 discloses a method for making a packaged dough suitable for extended refrigerated storage. The leavening of the dough is at least partially reacted to provide carbon dioxide distributed throughout the dough product. A hermetically sealed cover, extending at least over the top of the sidewalls to define the chamber containing the dough product and a headspace surrounding the dough product is provided. A gas comprising a predetermined amount of carbon dioxide is disposed in the headspace of the chamber in order to create an equilibrium level of carbon dioxide with the carbon dioxide produced in the dough product. The ambient air is replaced by the gas, thereby minimizing the amount of residual oxygen and hence, oxidation of the dough product. See the abstract.

### SUMMARY OF THE INVENTION

A frozen dough product is provided that comprises an unproofed frozen dough product comprising a leavening agent. The dough product is contained in an atmosphere enriched in a carbon dioxide concentration in an amount sufficient to enhance proofing of the frozen dough product as compared to a like frozen dough product not contained in an atmosphere enriched in carbon dioxide. Methods of manufacture and of use are also provided.

### DETAILED DESCRIPTION

The frozen dough product of the present invention exhibits surprisingly shorter proofing time as compared to prior frozen dough products that have not been contained in an atmosphere enriched in carbon dioxide. For purposes of the present invention, proof time is defined as the time required for the leavening system to double the volume of the dough. Preferably, the time required to proof the dough product is reduced by greater than 20 percent as compared to a like frozen dough product not contained in an atmosphere enriched in carbon dioxide. More preferably, the time required to proof is reduced by greater than 30 percent, and most preferably the time required to proof is reduced by greater then 40 percent as compared to a like frozen dough product not contained in an atmosphere enriched in carbon dioxide.

For purposes of the present invention, the term “unproofed” means that the dough is provided in a state wherein it contains sufficient unactivated leavening agent that the dough product will at least double in volume after removal from the freezer under proofing conditions. Thus, while some yeast or chemical leavening agent may have interacted with ingredients in the dough process during mixing to generate some gases, a sufficient amount of the leavening agent is still available to be utilized to proof the dough after thawing. For purposes of the present invention, the term “frozen” describes dough products that are maintained at a temperature below the freezing point of water, regardless of whether all ingredients in the dough product are actually in the frozen state.

While not being bound by theory, it is believed that the present invention provides for more efficient use of the gases generated by the leavening agents. This has particular benefit when some fermentation has already occurred in the case of yeast-containing doughs. While in some cases this premature fermentation may be merely incidental, in other dough products a preliminary fermentation process is purposefully carried out to provide superior flavor and texture properties of the final product. In either product type, the viability of the yeast may be reduced due to premature or preliminary fermentation processes. The remaining viable yeast cells are therefore critical to the success of the subsequent proofing step.

It is believed that this invention improves product quality via retention of carbon dioxide during shelflife. In conventional systems wherein the dough is stored in ordinary atmosphere, carbon dioxide is released into the packaging headspace and a new equilibrium is established with the atmosphere, which is mainly nitrogen. The net result is a significant decrease in the amount of dissolved carbon dioxide. When the dough is thawed and proofed, some of the carbon dioxide that is produced by the yeast must be used to resaturate the dough, i.e., to replenish that carbon dioxide that was lost from the dissolved phase to the atmosphere during frozen storage. In the present invention, packaging the dough in a carbon dioxide atmosphere prevents this loss of carbon dioxide. Thus, as carbon dioxide is produced during proofing of the thawed dough of the present invention, it can immediately start to expand the dough and therefore reduces the time it takes for the dough to double in volume.

The dough products of the present invention may be any of a wide range of dough products, including breads, rolls, and pastries. The dough products may be a laminated or a non-laminated dough, provided that the dough products eventually utilize a proofing step in its manufacture.

A dough for use in the method of the present invention can be formed in any suitable manner such as described above by the sponge method, the straight dough method, or the continuous dough method, as is known in the art. The particular formula for the dough will be dictated by the resulting end product. It can range anywhere from a bread to pastry. Breads have fat within a concentration range of 0% to about 6% and pastries generally have a fat content within a range of about 6% to about 30% by weight of the dough.

Generally, flour is present as about 50% to about 60% by weight of the dough, water as about 30% to about 40% by weight of the dough, and sugar as about 2% to about 8% by weight of the dough. Other dry minor ingredients, such as dough conditioners and salt, may be present.

Depending upon the type of leavening desired, a leavening agent can be added to the dough to provide the desired production of carbon dioxide to leaven the dough. The leavening agent may be either yeast or a chemical leavening agent, or a combination of the two. For purposes of the present invention, a chemical leavening agent is a combination of chemical ingredients that react to produce carbon dioxide. Preferably, these chemical ingredients are a combination of an acid and a base which react to release carbon dioxide, into the dough and thereby increase the volume of the dough. Suitable leavening acids are generally known in the industry and include but are not limited to citric acid, sodium acid pyrophosphate (SAPP), sodium aluminum phosphate (SALP), monocalcium phosphate (MCP), dicalcium phosphate (DCP), sodium aluminum sulfate (SAS), anhydrous monocalcium phosphate (AMCP), dimagnesium phosphate (DMP), dicalcium phosphate dihydrate (DCPD), gluconodelta lactone (GDL) and mixtures thereof. Suitable bases used in leavening agents generally include a carbonate and/or a bicarbonate salt. Suitable carbonate and bicarbonate salts include, for example, sodium carbonate, potassium carbonate, sodium bicarbonate (commonly known as baking soda), potassium bicarbonate, ammonium bicarbonate and mixtures thereof. An example of a preferred chemical leavening agent is the combination of sodium bicarbonate and glucono-delta-lactone. Typically, the leavening agent is provided as about 1% to about 6% by weight of the dough.

As described above, the dough is prepared preferably by either the sponge method or the straight-dough method. The dough is mixed in a suitable mixer. If the dough is to utilize a preliminary fermentation step as discussed above, such fermentation is preferably carried out prior to final shaping. Optionally, the dough is mechanically manipulated after preliminary fermentation to reduce volume of the dough prior to final shaping. The dough may optionally be sheeted or laminated. After sheeting and laminating, the product is cut and/or formed into a desired shape as is known.

The pieces of dough are frozen to their appropriate storage temperature before or after packaging in suitable packaging. The temperature of the product is less than 32° F. (0° C.), with the preferred storage temperature being in the range of about −60° F. (−51° C.) and about 20° F. (−7° C.), preferably in a range of between about −40° F. (−40° C.) and about 10° F. (−12° C.) and most preferably is in a range of between about −10 F. (−23° C.) and about 0° F. (−18° C.). Storage temperature may vary throughout storage time. It is preferred that these temperatures will be maintained for at least about 90% of the time the product is stored.

As stated above, the frozen dough products of the present invention are provided in an atmosphere enriched in carbon dioxide in an amount sufficient to enhance proofing of the frozen dough product as compared to a like frozen dough product not contained in an atmosphere enriched in carbon dioxide. Preferably, the atmosphere of the frozen dough product should contain at least about 50% by volume of carbon dioxide. More preferably, the atmosphere contains at least about 75% carbon dioxide, and most preferably at least about 90% carbon dioxide. The carbon dioxide gas can be added by gas flushing of the package using generally known techniques. Preferred packaging includes hermetically sealed packages with the packages being made of materials having suitable barrier properties to retain a gaseous carbon dioxide environment therein over the expected shelf life of the product.

In one preferred aspect of the present invention, a method of making a frozen dough product is provided by first preparing a dough product comprising a leavening agent. The dough product is then packaged in an atmosphere enriched in a carbon dioxide concentration in an amount sufficient to enhance proofing of the frozen dough product as compared to a like frozen dough product not contained in an atmosphere enriched in carbon dioxide. The product is then frozen in an unproofed state.

Alternatively, the dough product of the present invention may be stored in the frozen and unproofed state in a conventional atmosphere. Prior to proofing, the dough product is flushed with an atmosphere enriched in a carbon dioxide concentration in an amount and for a time sufficient to enhance proofing of the dough product as compared to a like dough product not contained in an atmosphere enriched in carbon dioxide.

In use, the frozen doughs of the present invention are placed in a temperature suitable for thawing for a sufficient time to thaw the dough to an extent necessary for the proofing process to take place. Preferably, the dough is completely thawed, i.e. no portions of the dough remain frozen. A preferred temperature for thawing is conventional ambient room temperature between about 20°-30° C. It may be most convenient to allow the frozen dough to thaw overnight. The thawed dough is then placed in an appropriate environment, such as a proof box, for proofing. After proofing is completed, the dough is cooked in an appropriate manner, such as by baking or flying.

As noted above, the dough of the present invention must be stored in the enriched carbon dioxide atmosphere for at least some time period prior to proofing. Preferably, the dough is stored in an enriched carbon dioxide atmosphere for the entire time that it is frozen. The dough may optionally be maintained in the carbon dioxide atmosphere environment during thaw. Optionally, the dough may also be maintained in the carbon dioxide atmosphere environment during proofing as well. Due to handling considerations, it may be more desirable to remove the packaging, thereby dissipating the carbon dioxide atmosphere, during either the thawing and/or the proofing step.

The invention will further be described by reference to the following nonlimiting examples.

### EXAMPLES

1. Evaluation Techniques

Proof times were determined with the use of a Risograph™ tester from R Design, Pullman Wash. Samples of dough were thawed overnight@4 C and then placed in jars attached to the Risograph™ tester. This unit measures the amount of gas produced as a function of time. The unit was run at 30 C. The time to produce 150 cc of gas per 100 g sample of dough was recorded. Samples were run in triplicate and the average of these three values was recorded as the time for the sample to double in volume.

2. Unfermented Dough

a) Dough is prepared according to the following formulation:

| | | |
|---|---|---|
| | % on | |
| | total | |
| | formula | |
| Ingredient | basis | Baker % |

Dough Assembly

| | | |
|---|---|---|
| Hard Flour, BL | 57.840 | 100.000 |
| Water | 34.760 | 60.096 |
| Gluten | 0.000 | 0.000 |
| Dough Conditioner | 0.400 | 0.692 |
| Salt | 1.000 | 1.729 |
| Shortening Chips | 2.000 | 3.458 |
| Compressed Yeast | 2.000 | 3.458 |
| Sucrose | 2.000 | 3.458 |

Dough Conditioner Pre-Blend

| | | |
|---|---|---|
| DATEM* w/amylase | 0.179 | 0.309 |
| Ascorbic Acid | 0.001 | 0.002 |
| Azodicarbonamide (10%) | 0.02 | 0.035 |
| Sodium Stearoyl lactylate | 0.2 | 0.346 |

*diacetyl tartaric acid esters of monoglycerides

Mix dry ingredients, add water and yeast, mix, add shortening, mix. Form into 100 g portions.

b) The one-hundred gram unfermented dough samples prepared as described above were placed in foil-laminated pouches. Half of the pouches were flushed with carbon dioxide. The pouches containing the dough samples were then heat sealed with a packaging iron. The finished system resembles an inflated pillow. The heat sealed pouch is stored@−18° C. until used. Sample identification and prooftimes are provided below:

Treatment and Prooftimes of Frozen
Unfermented Doughs @ 12 Weeks

| Treatment | Dough | Time to double in Volume |
|---|---|---|
| Not stored in carbon | Unfermented | 79 |
| dioxide (comparative) | | |
| Stored in carbon dioxide | Unfermented | 44 |

3. Fermented Dough

a) Dough is prepared according to the following formulation:

| | | |
|---|---|---|
| | % on | |
| | total | |
| | formula | |
| Ingredient | basis | Baker % |

Dough Assembly

| | | |
|---|---|---|
| Hard Flour, BL | 57.216 | 100.000 |
| Water | 34.384 | 60.096 |
| Gluten | 0.000 | 0.000 |
| Dough Conditioner | 0.400 | 0.699 |
| Salt | 1.000 | 1.748 |
| Shortening Chips | 2.000 | 3.496 |
| Compressed Yeast | 2.000 | 3.496 |
| Sucrose | 2.000 | 3.496 |
| Sucrose (for | 1.000 | 1.748 |
| preferment) | | |

Dough Conditioner Pre-Blend
Dough Assembly

| | | |
|---|---|---|
| DATEM w/amylase | 0.179 | 0.313 |
| Ascorbic Acid | 0.001 | 0.002 |
| Azodicarbonamide (10%) | 0.02 | 0.035 |
| Sodium Stearoyl lactylate | 0.2 | 0.350 |

Combine 400 g of the flour with all of the formula water, yeast and pre-ferment sucrose. Mix and hold at 30 C for 100 minutes to allow pre-fermentation of this pre-ferment composition. Combine the preferment composition with remaining dry ingredients, mix, add shortening, mix and form into 100 g portions.

b) The one-hundred gram fermented dough samples prepared as described above were placed in foil-laminated pouches. Half of the pouches were flushed with carbon dioxide. Pouches containing the dough samples were then heat sealed with a packaging iron. The heat-sealed pouch is stored@−18° C. until used.

Sample identification and prooftimes are provided below:

Proof times of Frozen Fermented Dough @ 12 Weeks

| Treatment | Dough | Time to double in Volume |
|---|---|---|
| Not stored in carbon | Fermented | 158 |
| dioxide (comparative) | | |
| Stored in carbon dioxide | Fermented | 94 |

What is claimed is:

1. A frozen dough product, comprising an unproofed frozen dough product comprising a leavening agent, wherein said dough product is contained in an atmosphere enriched in a carbon dioxide concentration in an amount sufficient to enhance proofing of the frozen dough product as compared to a like frozen dough product not contained in an atmosphere enriched in carbon dioxide.

2. The frozen dough product of claim 1, wherein said dough product is contained in an atmosphere enriched in a carbon dioxide concentration of at least about 50 percent by volume.

3. The frozen dough product of claim 1, wherein said atmosphere is enriched in a carbon dioxide concentration of at least about 75 percent by volume.

4. The frozen dough product of claim 1, wherein said atmosphere is enriched in a carbon dioxide concentration of at least about 90 percent by volume.

5. The frozen dough product of claim 1, wherein said leavening agent comprises yeast.

6. The frozen dough product of claim 5, wherein said frozen dough has undergone a preliminary fermentation prior to being frozen.

7. The frozen dough product of claim 1, wherein said leavening agent comprises a chemical leavening agent.

8. The frozen dough product of claim 7, wherein said chemical leavening agent is a mixture of sodium bicarbonate and glucono-delta-lactone.

9. The frozen dough product of claim 1, wherein said frozen dough product is a bread.

10. The frozen dough product of claim 1, wherein said frozen dough product is a roll.

11. The frozen dough product of claim 1, wherein said frozen dough product is a pastry.

12. The frozen dough product of claim 1, wherein said frozen dough product is a laminated dough.

13. The frozen dough product of claim 1, wherein said frozen dough product is a non-laminated dough.

14. A method of making the frozen dough product of claim 1, comprising:
a. preparing a dough product comprising a leavening agent;
b. packaging said dough product in an atmosphere enriched in a carbon dioxide concentration in an amount sufficient to enhance proofing of the frozen dough product as compared to a like frozen dough product not contained in an atmosphere enriched in carbon dioxide;
c. freezing said packaged dough product in an unproofed state.

15. The method of claim 14, wherein said dough product is contained in an atmosphere enriched in a carbon dioxide concentration of at least about 50 percent by volume.

16. The method of claim 14, wherein said atmosphere is enriched in a carbon dioxide concentration of at least about 75 percent by volume.

17. The method of claim 14, wherein said atmosphere is enriched in a carbon dioxide concentration of at least about 90 percent by volume.

18. A method of making the frozen dough product of claim 1, comprising:
a. preparing a dough product comprising a leavening agent; freezing said dough product in an unproofed state in a conventional atmosphere;
b. prior to proofing, flushing said frozen dough product with an atmosphere enriched in a carbon dioxide concentration in an amount and for a time sufficient to enhance proofing of the dough product as compared to a like dough product not contained in an atmosphere enriched in carbon dioxide.

19. The method of claim 18, wherein said dough product is contained in an atmosphere enriched in a carbon dioxide concentration of at least about 50 percent by volume.

20. The method of claim 18, wherein said atmosphere is enriched in a carbon dioxide concentration of at least about 75 percent by volume.

21. The method of claim 18, wherein said atmosphere is enriched in a carbon dioxide concentration of at least about 90 percent by volume.

22. A method of using the frozen dough product of claim 1, comprising:
a. providing an unproofed frozen dough product comprising a leavening agent, wherein said dough product is contained in an atmosphere enriched in a carbon dioxide concentration in an amount sufficient to enhance proofing of the frozen dough product as compared to a like frozen dough product not contained in an atmosphere enriched in carbon dioxide, thereby providing an unproofed frozen dough product;
b. allowing said unproofed frozen dough product to thaw, thereby providing a thawed unproofed frozen dough product;
c. allowing said thawed unproofed frozen dough product to proof to a volume exceeding about 100 percent of the unproofed frozen dough product volume, thereby providing a proofed dough product;
d. cooking said proofed dough product.
